(19) United States
(12) Patent Application Publication
(10) Pub. No.: US 2012/0143720 A1
(43) Pub. Date: Jun. 7, 2012

(54) LOCATION BASED MOBILE SHOPPING

(76) Inventor: MARTIN MOSER, Speyer (DE)

(21) Appl. No.: 12/961,550

(22) Filed: Dec. 7, 2010

(51) Int. Cl. G06Q 30/00; G01C 21/34

(52) U.S. Cl. 705/26.8

(57) ABSTRACT

Disclosed are methods and systems for location based mobile shopping. The methods and systems involve receiving a wish list according to a user request on a computing device, the wish list including one or more items, price associated with the one or more items, a maximum shop distance preferred by the user, identifying one or more shops within the maximum distance preferred by the user based on a geographical location of the user computing device, retrieving item lists from one or more identified shops, matching the one or more items on the received item list with the one or more items in the wish list of the user and generating an alert to the user upon matching the items in the wish list of the user.

### FIELD

The field generally relates to wish lists and more specifically related to location based mobile shopping wish lists.

### BACKGROUND

In the modern world, maintaining wish lists is gaining popularity. Generally, the wish lists include a list of items required by a user. The wish list may also include a price preferred by the user for each item. The existing methods involve the process of the user selecting any of the items on a website and adding that particular item to the wish list. Another type of wish list may be a gift registry including items that may be purchased at a store which manages the registry. Generally the wish lists are maintained online and are mostly created by software manufacturers such as the software development company or the website owner. Yet another type of wish list may be a manual wish list maintained by the user, in which case the user may need to spend considerable time to search for the required items in various shops. There is a need for maintaining wish lists which may enable the user to shop based on geographical locations.

### SUMMARY

Various embodiments of systems and methods for location based mobile shopping are described herein. The methods and systems involve receiving a wish list according to a user request on a computing device, the wish list including one or more items, price associated with the one or more items, a maximum shop distance preferred by the user, identifying one or more shops within the maximum distance preferred by the user based on a geographical location of the user computing device, retrieving item lists from one or more identified shops, matching the one or more items on the received item list with the one or more items in the wish list of the user and generating an alert to the user upon matching the items in the wish list of the user.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments, together with their advantages, may be best understood from the following detailed description taken in conjunction with the accompanying drawings.

FIG. 1 is a block diagram illustrating an exemplary method for location based mobile shopping according to an embodiment.

FIG. 2 is a flow diagram illustrating an exemplary method for location based mobile shopping according to an embodiment.

FIG. 3 is a flow diagram illustrating an exemplary business scenario for matching the items in the wish list with the items in the shop according to an embodiment.

FIG. 4 is a block diagram of an exemplary business scenario of a matching server in a shop database according to an embodiment.

FIG. 5 is a block diagram of a business scenario of a matching server residing outside a user computing device according to an embodiment.

FIG. 6 is a block diagram of an exemplary system for location based mobile shopping according to an embodiment.

FIG. 7 is a block diagram of an exemplary computer system according an embodiment.

### DETAILED DESCRIPTION

Embodiments of techniques for location based mobile shopping are described herein. In the following description, numerous specific details are set forth to provide a thorough understanding of various embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

A wish list is a collection of items a user intends to possess. The wish list may include a plurality of items according to the user's needs. The wish list may also include the price associated with the plurality items. The wish list may be a web based application and/or a mobile application. The wish list may be installed in the form of an application in a mobile computing device of the user. The user may enter items along with the preferred price. Each item includes item specifications such as name of the item, color of the item, version or edition of the item.

On receiving a user request for an item, the item is entered in the wish list application along with the price. The user may also enter a maximum distance to travel to reach a shop. A GPS (global positioning system) application determines the geographical location of the user computing device. Based on the geographical location of the user computing device, shops in the vicinity are searched. The shops in the vicinity of the user computing device may have posted offer prices associated with items into a matching server. The matching server compares the items in the wish list with the discounted items posted by the shop. If the matching server identifies the item in the shop, the shop is short listed. On short listing the shop, the matching server compares a distance between the location of the user and at least one shop in the vicinity of the user according to the items offered by the shop. If the distance of the shop is same as or less than the maximum distance preferred by the user, an alert is generated on the user computing device.

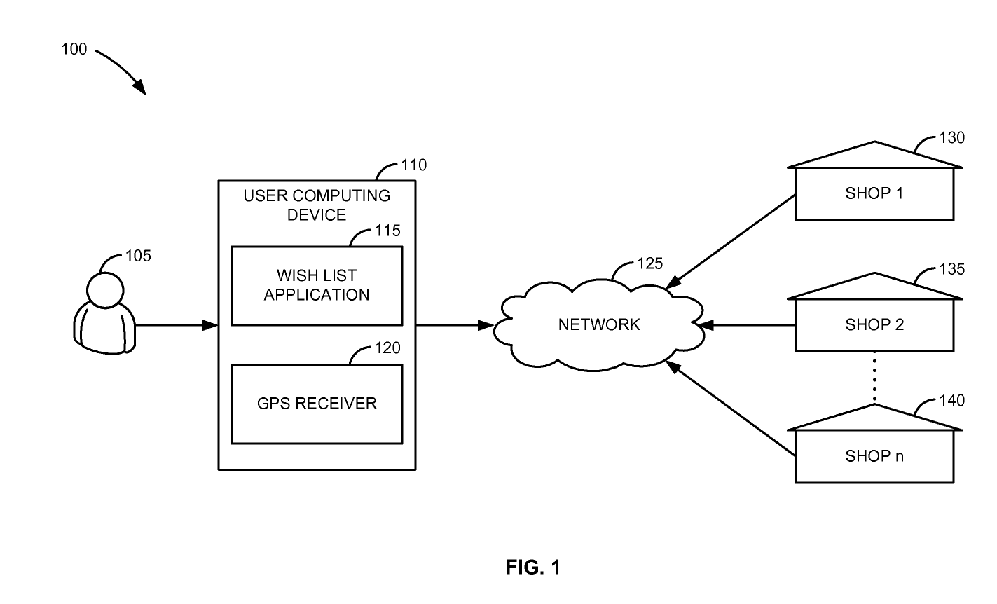

FIG. 1 is a block diagram illustrating an exemplary method for location based mobile shopping according to an embodiment. Consider a scenario 100 including a user 105, user computing device 110, a network 125, and shop 1 130, shop 2 135 and shop n 140. The user computing device 110 includes a wish list application 115 and GPS receiver 120. The user computing device 110 is a mobile device. The user 105 updates the wish list application 115 with items, price associated with the items. Alternatively the user 105 may also mention the preferred brand, color, etc. of the item. The user 105 may also mention the desirable maximum distance to a shop.

Consider that the user 105 updates the wish list application 115 with the wish list item “iPod” of brand Apple® for price $100. The maximum distance of the shop preferred by the user 105 is 3 miles. The user 105 is passing by a geographical location XYZ, the GPS receiver 120 determines the location of the user computing device 110. Based on the details entered in the wish list, the wish list application 115 searches for shops in the vicinity of the user 105 based on the geographical location determined by the GPS receiver 120. If shop 2 135 is offering an Apple® iPod at $100 or less, and the maximum distance of shop 2 135 is equal to or less than 3 miles, the shop 2 135 is shortlisted. The communication between the user computing device 110 and the shops shop 1 130, shop 2 135 and shop n 140 is established through the network 125. In one embodiment, the user computing device 110 may include a matching server to match the items in the wish list with the items available in the shop. The matching server may also be used to match the details in the wish list such as maximum shop distance and price of the item.

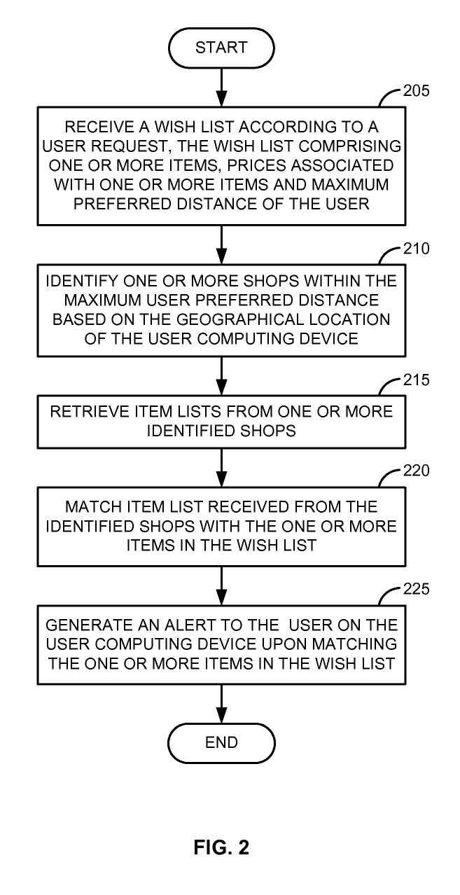

FIG. 2 is a flow diagram illustrating an exemplary method for location based mobile shopping according to an embodiment. At process block 205, a wish list is received according to a user request on a computing device. The wish list includes one or more items, price associated with the one or more items and maximum shop distance preferred by the user. At process block 210, based on a geographical location of the user computing device, one or more shops are identified within the geographical location of the user computing device. The geographical location of the user computing device is determined by a GPS receiver on the user computing device. At process block 215, item lists are retrieved from the one or more identified shops. In one embodiment, retrieving the item list from the identified shops includes retrieving offers associated with the items available in the shop. At process block 220, one or more items in the item list received from the identified shops are matched with the one or more items in the wish list of the user. In one embodiment, the items are matched on a matching server. The matching servers are present in the computing devices associated with the one or more identified shops. At process block 225, upon matching the items in the wish list an alert is generated to the user on the user computing device. The alert may indicate the name of the shop where the item is available along with the price of the item. In one embodiment, the alert may also include a route map to the shop.

In one embodiment, computing devices associated with the one or more identified shops include a matching module within the matching server for matching the items in the wish list with the items offered in the shop. The matching server includes a database in which the offers associated with the items are stored.

In another embodiment, the matching module is present on a matching server residing outside the computing device. The matching server receives the list of items with discounted prices from the shop. The matching server also receives the list of items in the wish list from the user. The matching module in the matching server matches the items in the wish list with the items in the shop.

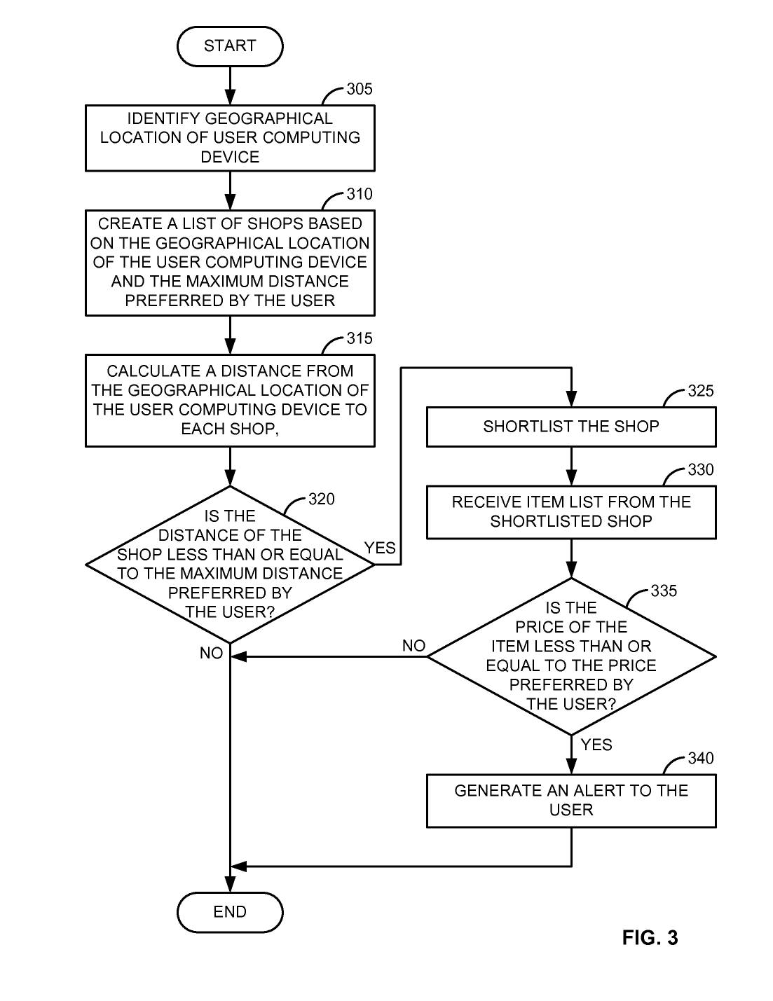

FIG. 3 is a flow diagram illustrating an exemplary business scenario for matching the items in the wish list with the items in the shop according to an embodiment. At process block 305, geographical location of a user computing device is identified. At process block 310, shop list is created based on the geographical location of the user computing device and the maximum distance preferred by the user. At process block 315, distance from the geographical location of the user computing device to the shop is calculated for each shop. At decision block 320, it is checked whether the distance of the shop is less than or equal to the maximum distance preferred by the user. The condition of decision block 320 is checked for each identified shop. If the distance is less than or equal to the maximum distance preferred by the user, the shop is shortlisted. At process block 325, the shop is shortlisted. At process block 330, item list is received from the shortlisted shop. The process proceeds to decision block 335. At decision block 335, it is checked whether the price of the item is less than or equal to the price preferred by the user. If the price of the item is less than or equal to the user preferred price, an alert is generated to the user at process block 340. The alert is generated to the user computing device and includes shop name, the item, the price associated with the item and the distance of shop from the current location of the user computing device.

At decision block 320, if the distance of the shop is more than the maximum distance preferred by the user the process ends. At decision block 335, if the price of the item is more than the price preferred by the user the process ends.

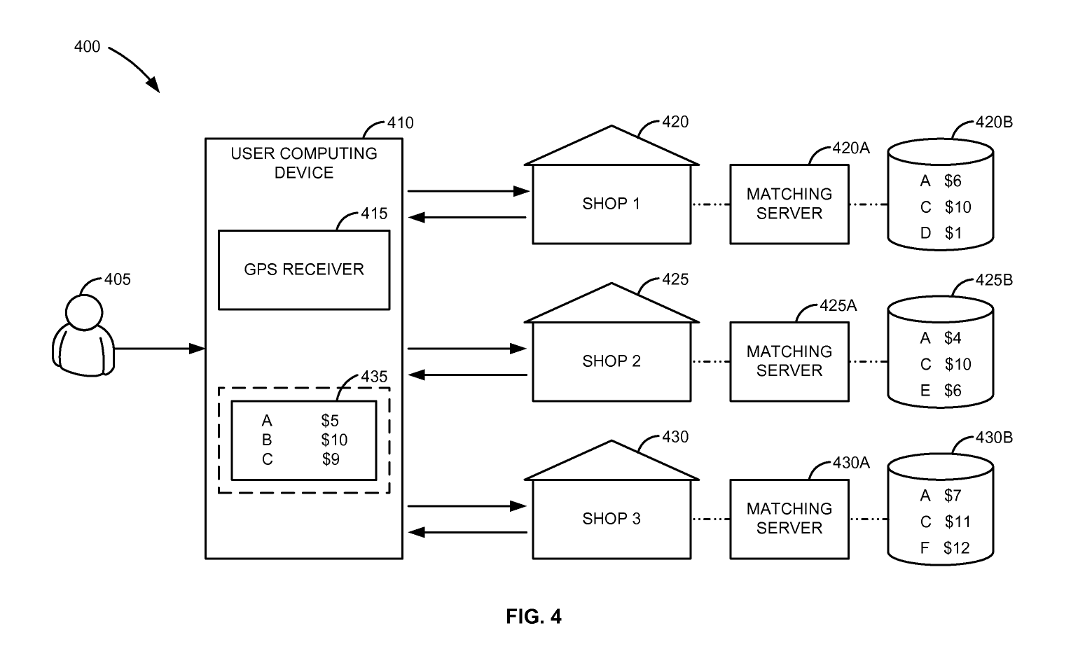

FIG. 4 is a block diagram of an exemplary business scenario of a matching server in a shop database according to an embodiment. Consider a business scenario 400 including a user 405, a user computing device 410, and shop 1 420, shop 2 425 and shop 3 430. The shops shop 1 420, shop 2 425 and shop 3 430 include matching servers 420A, 425A and 430A respectively. The user computing device 410 may include a GPS receiver 415 and a wish list 435. The user computing device 410 may include a wish list 435 in a wish list application. The wish list 435 may maintain data associated with the list of items received from the user 405. The data associated with the items may include item specification such as detailed name, item quantity, brand of the item, price of the item and so on. The user 405 also inputs maximum distance of a shop. The maximum distance may be used by the wish list application for searching shops in the vicinity of the geographical location of the user computing device 410. The geographical location of the user computing device 410 is determined by the GPS receiver 415. Shops shop 1 420, shop 2 425 and shop 3 430 are identified within the maximum distance preferred by the user of the user computing device 410. For each shop in the vicinity of the geographical location, the wish list application calculates the distance from the location of the user computing device 410 to the identified shops. The shops are shortlisted based on the wish list. On short listing the shop, the price for the item in the shop associated with the user's wish list is checked. The price for the item may be stored in a database of the shop (e.g., 420B, 425B and 430B). The matching servers 420A, 425A and 430A check if the price is less than or equal to the price the user wants to pay. If the price is less than or equal to the price the user wants to pay, an alert is generated on the user computing device 410. The alert may include the list of items available at the shop according to the prices the user wants to pay, distance to the shop from the location of the user and so on. If there is more than one shop offering the items, the shops may be shortlisted according to the distance or the price of the item.

In the business scenario 400, the wish list 435 includes items A, B and C for prices $5, $10 and $9 respectively. Based on the user's geographical location three shops are identified. The matching servers 420A, 425A and 430A find a match associated with item A in shop 1 420, shop 2 425 and shop 3 430 the associated prices being $6, $4 and $7 respectively. As the shop 2 425 is offering the item A at a price less than the user preferred price, an alert is generated at the user computing device 410 of the user. The matching servers 420A, 425A and 430A also find a match for item C in shop 1 420, shop 2 425 and shop 3 430 the associated prices being $10, $10 and $11 respectively. As the price of the item C is more than the user preferred price, the alert is not generated.

In one embodiment, the matching server resides on the user computing device 410. The matching of the items in the wish list with the item list received from the identified shops are matched on the user computing device 410.

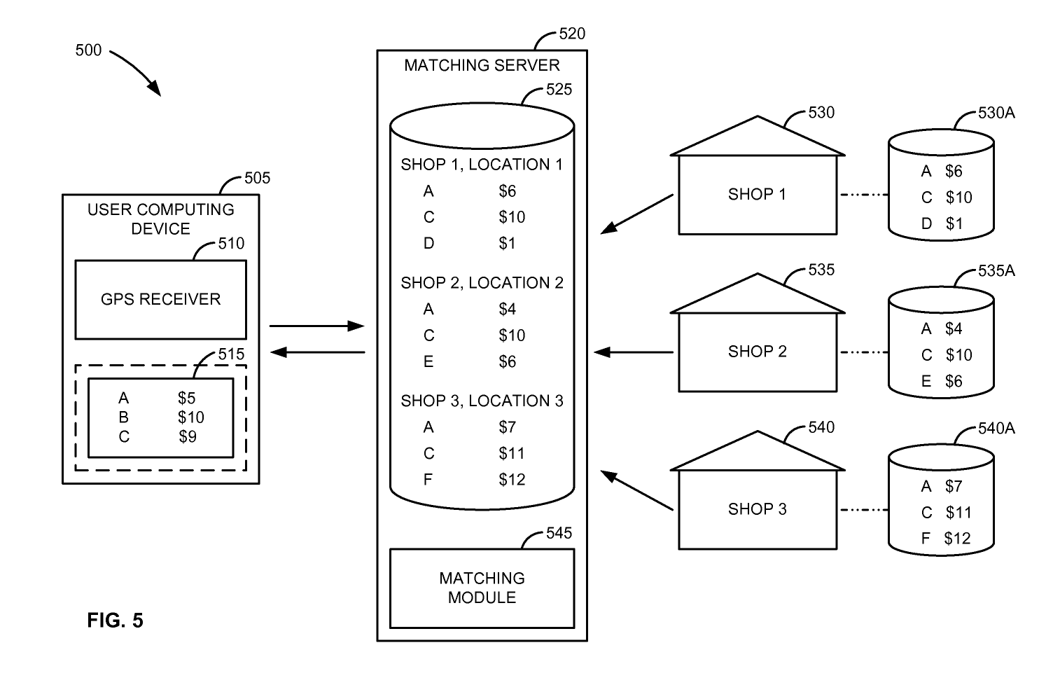

FIG. 5 is a block diagram of a business scenario of a matching server residing outside a user computing device 505 according to an embodiment. The user computing device 505 maintains and stores the wish list 515 in a wish list application. A geographical location of the user computing device 505 is determined by a GPS receiver. The wish list 515 and the geographical location are updated to a matching server 520. The matching server 520 also receives an item list from shops. Based on the wish list 515 and geographical location of the user computing device 505, shops are identified. The one or more items on the item lists associated with the identified one or more shops are matched with the one or more items in the wish list 515 of the user on the matching server 520. On matching the one or more items in the wish list 515 of the user an alert is generated to the user computing device 505 of the user.

The matching server 520 may include a matching module 545 for matching the items. The matching server 520 may be a database including the offers posted by the shops. The matching server 520 maintains a database of shops, shop locations, items available in each shop and price of each item. The shops shop 1 530, shop 2 535 and shop 3 540 also post the item list along with the prices on the matching server 520. The prices are stored in a shop database 530A, 535A and 540A. In one embodiment, the database maintains the data in a table format. The user may update the matching server 520 with the wish list 515 including items, price associated with the items, geographical location and preferred maximum shop distance. The matching server 520 searches the database to identify shops suitable for the user according to the items, price and distance of the shop.

In one embodiment, the matching server 520 receives the updates from the shops through the internet. The communication between the user computing device 505 and the shops shop 1 530, shop 2 535 and shop 3 540 may be established through a network. In another embodiment, the shops post the offers on the available items on the matching server 520.

In another embodiment, the matching server 520 includes entries according to shop name and geographical location. The items available in the shop are listed below the name of the shop along with the price of the item.

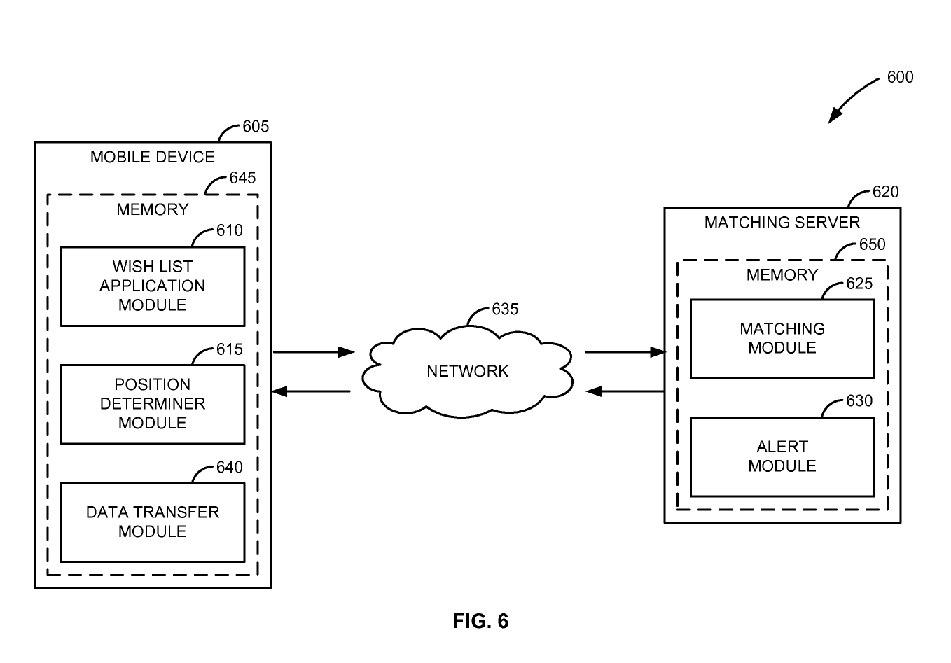

FIG. 6 is a block diagram of an exemplary system 600 for location based mobile shopping according to an embodiment. The computer system 600 includes a mobile device 605, and a matching server 620 that may be accessed through a network 635. A processor (not shown), in communication with the memory 645 of the mobile device 605 includes instructions for the wish list application module 610, a position determiner module 615 and a data transfer module 640 to perform required operations. The wish list application module 610 receives a wish list from the user, the wish list including one or more items, price associated with the one or more items, a maximum shop distance preferred by the user. The position determiner module 615 determines the geographical location of the mobile device 605. The data transfer module 640 transfers the wish list and the geographical location of the mobile device 605 to the matching server 620.

The matching server 620 includes matching module 625 and alert module 630. A processor (not shown), in communication with the memory 650 of the matching server 620 includes instructions for the matching module 625 and alert module 630 to perform required operations. The matching server 620 retrieves item list from one or more shops. The matching server 620 identifies one or more shops based on the geographical location of the mobile device 605 and the wish list. One or more items on the retrieved item list are matched with the one or more items in the wish list of the user by a matching module 625. Upon matching the items an alert is generated by the alert module 630.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

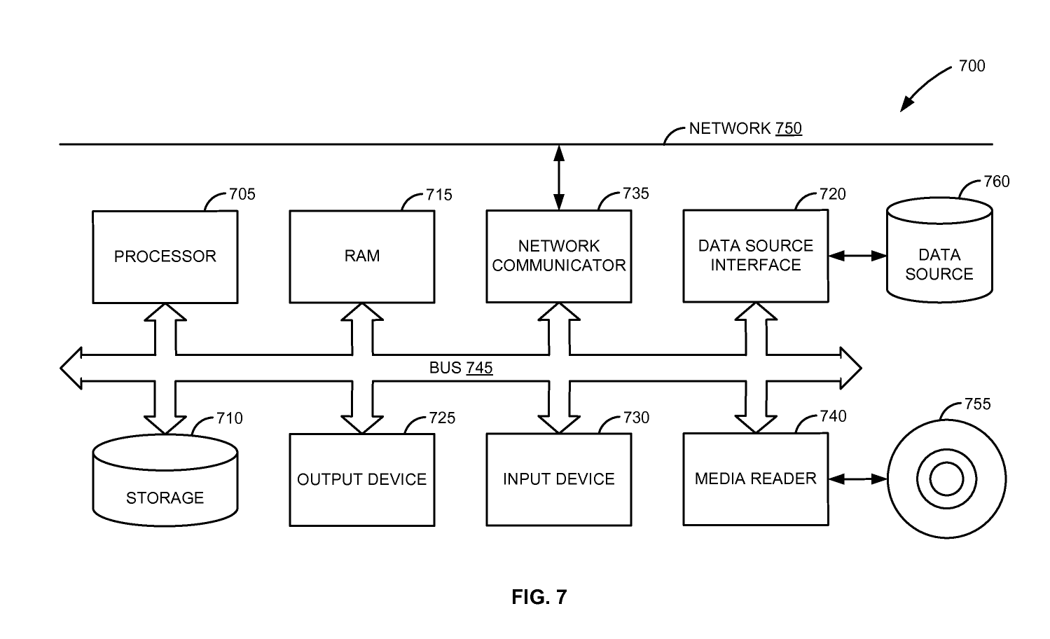

FIG. 7 is a block diagram of an exemplary computer system 700 according to an embodiment. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interacting with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however, that the invention can be practiced without one or more of the specific details or with other methods, components, techniques, etc. In other instances, well-known operations or structures are not shown or described in detail to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive a wish list according to a user request from a user computing device, the wish list including one or more items, prices associated with the one or more items and a maximum shop distance preferred by the user;
based on a geographical location of the user computing device, identify one or more shops within the maximum shop distance preferred by the user;
retrieve item lists from the identified one or more shops;
match the one or more items in the item list of the identified shop with the one or more items in the wish list of the user; and
upon matching the one or more items in the wish list of the user, generate an alert to the user on the user computing device.

2. The article of manufacture in claim 1, wherein retrieving the item lists from the identified one or more shops comprises retrieving the item lists from a database in a computing device of the shop.

3. The article of manufacture in claim 2, wherein the database comprises storing data associated with the items in a table format.

4. The article of manufacture in claim 1, wherein matching the one or more items in the item list of the shop with the one or more items in the wish list of the user comprises matching on a matching server.

5. The article of manufacture in claim 1, wherein generating an alert comprises generating a route map to the identified shop.

6. A computer system for location based mobile shopping, comprising:
a processor; and
one or more memory elements in communication with the processor for storing:
a wish list application module in a mobile device for receiving a wish list from the user, the wish list including one or more items, prices associated with the one or more items and a maximum shop distance preferred by the user;
a position determining module in the mobile device for determining a geographical location of the mobile device;
a data transfer module in the mobile device for transferring the wish list and the geographical location of the mobile device from the mobile device to a matching server; and
the matching server for,
retrieving item lists from one or more shops,
identifying one or more shops based on the geographical location of the mobile device and wish list, and
matching the one or more items on the retrieved item list with the one or more items in the wish list of the user and generating an alert to the user upon matching the items.

7. The computer system of claim 6, wherein the matching server comprises an alert module to generate the alert to the user.

8. The computer system of claim 7, wherein the alert module generates a route map to the identified shop.

9. The computer system of claim 7, wherein the alert module sends the alert to the user computing device.

10. The computer system of claim 6, wherein the matching server comprises a database.

11. The computer system of claim 10, wherein the database stores offer prices associated with one or more items offered by the shop.

12. The computer system of claim 6, wherein the matching server comprises a matching module.

13. A computerized method for location based mobile shopping, comprising:
receiving a wish list according to a user request from a user computing device, the wish list including one or more items, price associated with the one or more items and a maximum shop distance preferred by the user;
determining the geographical location of the user computing device;
updating a matching server with the wish list and the geographical location of the user computing device;
retrieving item lists from one or more shops to the matching server;
based on the geographical location of the user computing device and the wish list, identifying one or more shops;
matching the one or more items on the item lists associated with the identified one or more shops with the one or more items in the wish list of the user; and
upon matching the one or more items on the retrieved item list with the one or more items in the wish list of the user, generating an alert to the user.

14. The computerized method of claim 13, wherein determining the geographical location of the user computing device comprises receiving signal from a global positioning system determining a current geographical location of the user computing device.

15. The computerized method of claim 13, wherein the matching server comprises a database.

16. The computerized method of claim 15, wherein the database stores offer prices associated with one or more items offered by the shop.

17. The computerized method of claim 15, wherein the database comprises storing data associated with the items in a table format.

18. The computerized method of claim 13, wherein matching the one or more items on the item lists associated with the identified one or more shops comprises matching in a matching module of the matching server.

19. The computerized method of claim 13, wherein generating the alert to the user comprises generating the alert on the user computing device.

20. The computerized method of claim 13, wherein generating the alert comprises generating a route map to the identified shop.
